(19) United States
(12) Patent Application Publication
(10) Pub. No.: US 2017/0182682 A1
(43) Pub. Date: Jun. 29, 2017

(54) FLEXIBLE MOLD

(71) Applicant: HUEY ERL CHYANG ENTERPRISE LTD., TAIPEI CITY (TW)

(72) Inventor: TAIN-BOA HONG, TAIPEI CITY (TW)

(21) Appl. No.: 14/979,529

(22) Filed: Dec. 28, 2015

(51) Int. Cl. B29C 33/50

(52) U.S. Cl. CPC B29C 33/50; B29L 2031/757

(57) ABSTRACT

A flexible mold includes: a flexible main body, a first opening and second opening being respectively configured on the two ends thereof, a first accommodation space being defined inside the main body, the main body being reduced gradually form top to bottom; a flexible extrusion unit, having a third opening and second accommodation space, the third opening is in connection with the second opening, allowing the second accommodation space to be in communication with the first accommodation space, the extrusion unit is reduced gradually from top to bottom, and the bottom thereof is an arc-shaped body; and a flexible seat, being a hollow column, and expanded gradually from top to bottom, the top of the seat being in combination with the bottom of the main body and the top of the extrusion unit. Whereby, the ice cube formed in the flexible mold can be released easily.

### TECHNICAL FIELD OF THE INVENTION

The present invention relates to a mold, and more particularly to a flexible mold capable of easy mold release.

### DESCRIPTION OF THE PRIOR ART

The current market available ice boxes usually are a fixed shape box body inside which many cells are formed for liquid to be poured in. However, ice cubes cannot be taken out easily because they will stick to cells after the liquid inside the cells are frozen into ice cubes, causing considerable distress to users. In order to release ice cubes from the cells easily, the outer edge of the ice box must first be wetted with water to melt the ice cubes in the cells slightly, and the ice box is then banged so as to release ice cubes. But, the manner mentioned above is time and labor consuming and causes damage to the ice box or causes the released ice cubes to be broken to speed their melting, further to influence the freezing efficiency.

### SUMMARY OF THE INVENTION

The main object of the present invention is to provide a flexible mold, made of flexible material, allowing ice cube to be released therefrom easily, the ice cube made thereby being a long strip body capable of being placed inside an accompanying cup, and the mold being a thin and tough structure and unable to be broken, capable of repeated use.

To achieve the object mentioned above, the present invention proposes a flexible mold, including: a flexible main body, a first opening and second opening being respectively configured on two ends thereof, and a first accommodation space being defined inside the main body, the main body being reduced gradually from top to bottom; a flexible extrusion unit, having a third opening and second accommodation space, the third opening being in connection with the second opening, allowing the second accommodation space to be in communication with the first accommodation space, the extrusion unit being reduced gradually from top to bottom, and a bottom thereof being an arc-shaped body; and a flexible seat, being a hollow column expanded gradually from top to bottom, a top of the seat being in combination with the bottom of the main body and a top of the extrusion unit. Thereupon, ice cube is pushed from a bottom of the extrusion unit after liquid inside the first accommodation space is frozen to ice, allowing an inner side of the extrusion unit to enter the first accommodation space, thereby releasing ice cube form the first accommodation space conveniently.

### BRIEF DESCRIPTION OF THE DRAWINGS

FIG. 1 is a perspective view of the present invention;

FIG. 2 is an exploded view of the present invention;

FIG. 3 is a cross-sectional view of the present invention;

FIG. 4 is a schematic view of the present invention in a use state;

FIG. 5 is a schematic view, showing the continuation of the use state of FIG. 4; and

FIG. 6 is a schematic view, showing the continuation of the use state of FIG. 5.

### DETAILED DESCRIPTION OF THE PREFERRED EMBODIMENTS

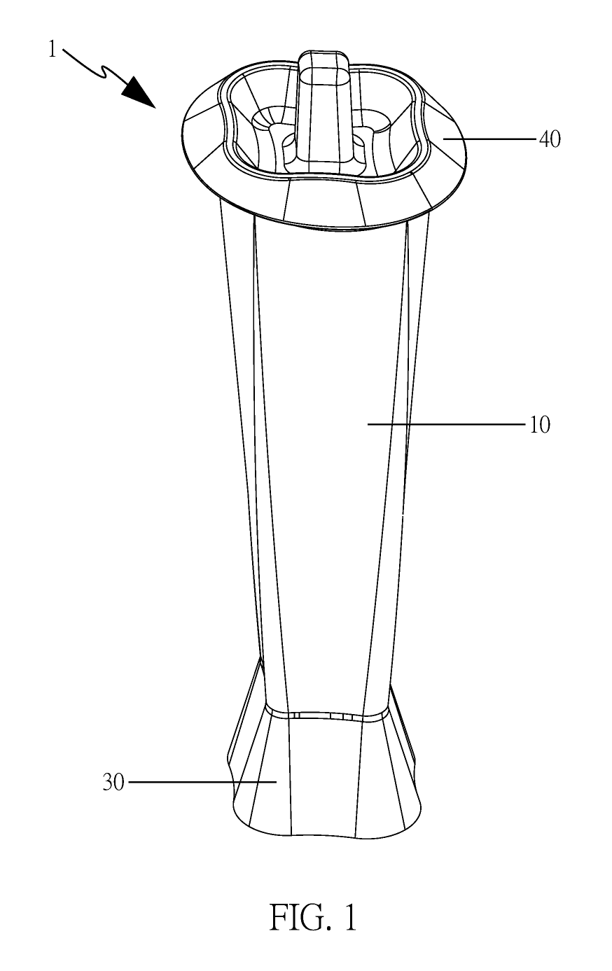

Referring to FIG. 1, a flexible mold of the present invention includes a first flexible main body 10, flexible extrusion unit 20, flexible seat 30 and cover 40.

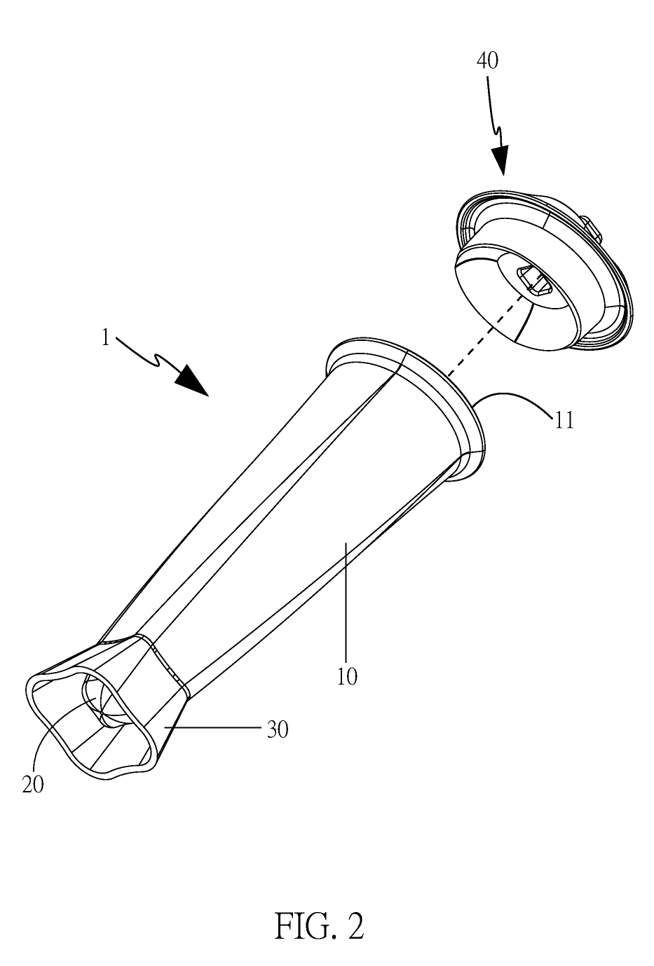

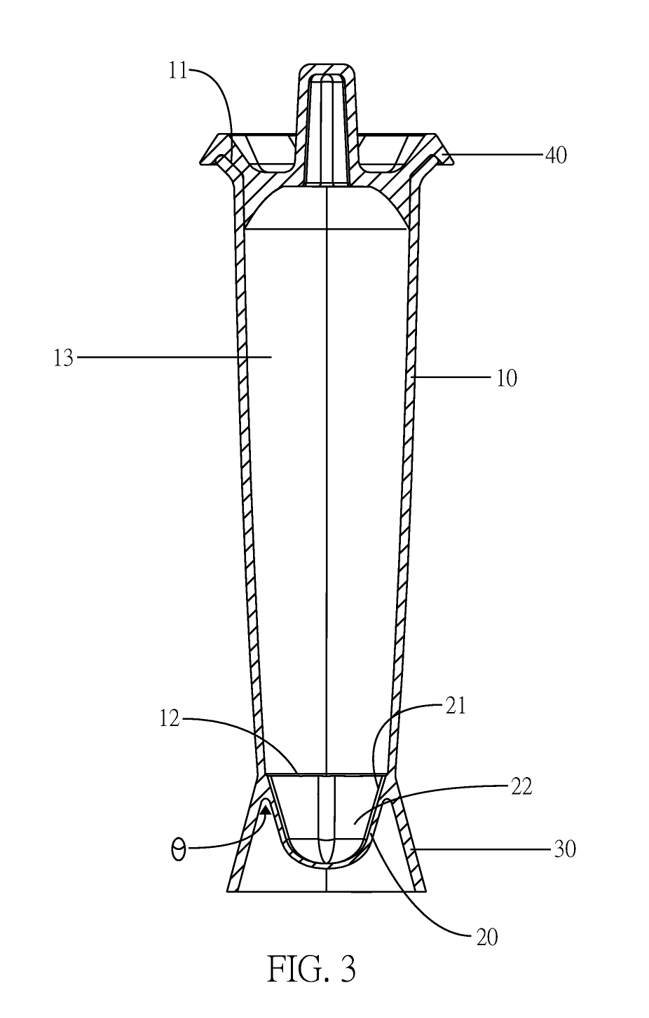

Referring to FIGS. 2 and 3, a first opening 11 and second opening 12 are respectively configured on the two ends of the flexible main body 10, and a first accommodation space 13 is defined inside the main body 10, the main body 10 being reduced gradually from top to bottom.

The flexible extrusion unit 20 has a third opening 21 and second accommodation space 22, and the third opening 21 is in connection with the second opening 12 of the main body 10, allowing the second accommodation space 22 to be in communication with the first accommodation space 13.

The extrusion unit 20 is reduced gradually from top to bottom, and the bottom of the extrusion unit 20 is an arc-shaped body.

The wall thicknesses of the main body 10 and extrusion unit 20 are respectively decreased gradually from top to bottom, i.e. the main body 10 and extrusion unit 20 respectively become thinner gradually from top to bottom; the outer side of the top of the main body 10 is cylindrical, and the outer side of the bottom of the main body 10 and the outer side of the top of the extrusion unit 20 respectively are a smoothing quadrilateral. In the embodiment, the wall thickness of the main body 10 at the top end thereof is 2.4 cm and decreased gradually from top to bottom so that the wall thickness thereof at the second opening 12 is 2 cm; the wall thickness of the extrusion unit 20 at the top thereof is 1.5 cm and decreased gradually from top to bottom to 1.3 cm at the bottom thereof. The description mentioned above is only an example of thickness ratio of the main body 10 and extrusion unit 20, but the present invention is not so limited.

The flexible seat 30 is a hollow column and expanded gradually from top to bottom. Furthermore, the top of the seat 30 is in combination with the bottom of the main body 10 and the top of the extrusion unit 20.

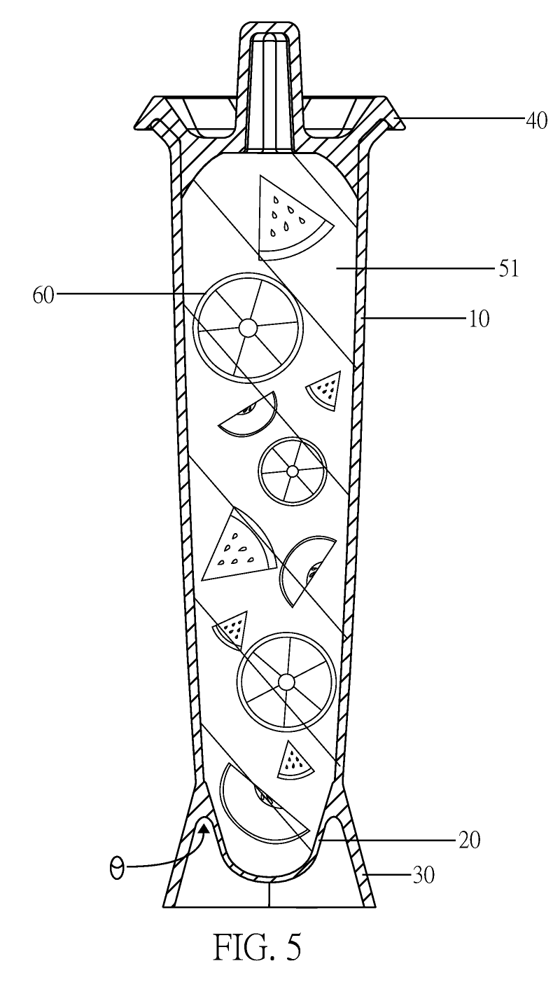

Referring to FIGS. 3 to 5, the main body 10, extrusion unit 20 and seat 30 are formed into on body, and an arc angle θ is formed at the position where the extrusion unit 20 is in combination with the seat 30.

The cover 40 is adapted to be in combination with the first opening 11 and seal the first accommodation space 13 of the main body 10 in an air-tight or liquid-tight way.

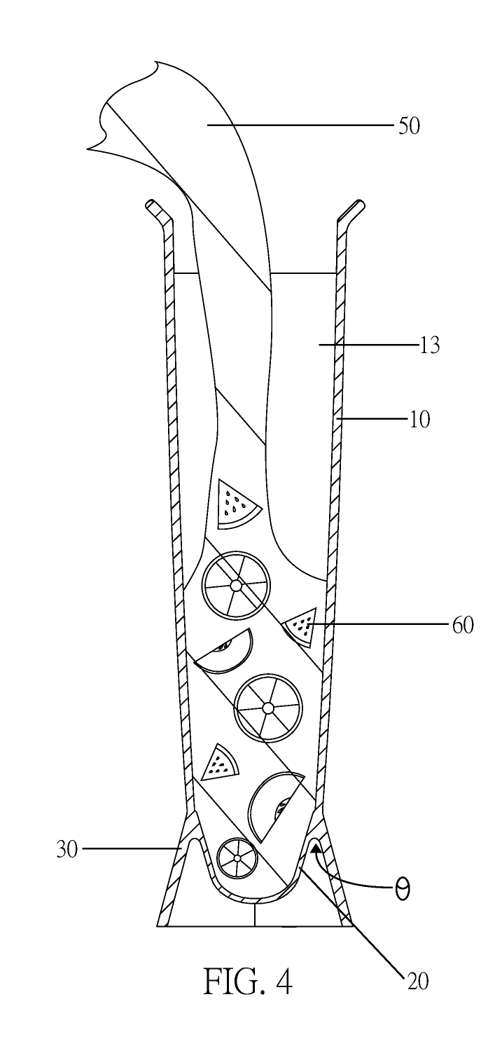

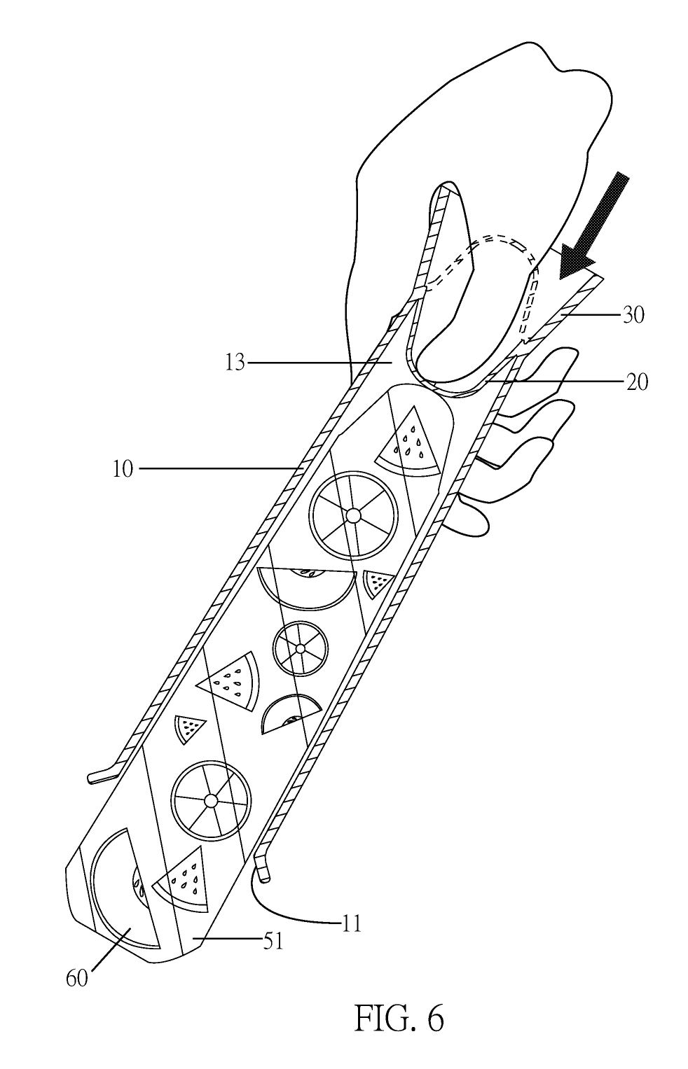

Referring to FIGS. 4 to 6, when the present invention is put into use, liquid 50 is filled in the first accommodation space 13 of the main body 10, and the cover 40 is used to seal the first accommodation space 13 of the first main body 10. In the embodiment, at least one kind of fruit 60 may be added in the liquid 50. Thereafter, the flexible mold 1 filled with the liquid 50 is placed in a freezer for refrigeration, forming the liquid 50 into an ice cube 51.

The flexible mold 1 of the present invention is made from rubber or silicone so that a user may hold the main body 10 and then twist the seat 30, thereby releasing the ice cube from the first accommodation space 13 more easily.

Thereafter, the user may push the bottom of the extrusion unit 20 to force the inner side of the extrusion unit 20 into the first accommodation space 13 so that the ice cube can then be pushed out.

The extrusion unit 20 is allowed to be thin in thickness and tough in strength, preventing it from being broken when it is pushed because the arc angle θ is formed between the extrusion unit 20 and seat 30 at the position where the extrusion unit 20 in combination with the seat 30.

I claim:

1. A flexible mold, comprising:
a flexible main body, a first opening and second opening being respectively configured on two ends thereof, and a first accommodation space being defined inside said main body, said main body being reduced gradually from top to bottom;
a flexible extrusion unit, having a third opening and second accommodation space, said third opening being in connection with said second opening, allowing said second accommodation space to be in communication with said first accommodation space, said extrusion unit being reduced gradually from top to bottom, and a bottom of said extrusion unit being an arc-shaped body, an inner side of said extrusion unit being caused to enter said first accommodation space when said bottom of said extrusion unit is pushed by force; and
a flexible seat, being a hollow column, and expanded gradually from top to bottom, a top of said seat being in combination with a bottom of said main body and a top of said extrusion unit.

2. The flexible mold according to claim 1, wherein said main body, extrusion unit and seat are integrated into one body and an arc angle is formed at a position where said extrusion unit is in combination with said seat.

3. The flexible mold according to claim 2, wherein wall thicknesses of said main body and extrusion unit are respectively reduced gradually form top to bottom, allowing said wall thickness of said top of said main body to be larger than said wall thickness of said bottom of said main body, and allowing said wall thickness of said top of said extrusion unit is larger than said wall thickness of said arc-shaped bottom.

4. The flexible mold according to claim 1, wherein an outer side of said top of said main body is cylindrical, and an outer side of said bottom of said main boy and an outer side of said top of said extrusion respectively being a smoothing quadrilateral.

5. The flexible mold according to claim 2, wherein an outer side of said top of said main body is cylindrical, and an outer side of said bottom of said main boy and an outer side of said top of said extrusion respectively being a smoothing quadrilateral.

6. The flexible mold according to claim 3, wherein an outer side of said top of said main body is cylindrical, and an outer side of said bottom of said main boy and an outer side of said top of said extrusion respectively being a smoothing quadrilateral.

7. The flexible mold according to claim 1, wherein said first opening of said main body is further in combination with a cover adapted to seal said first accommodation space of said main body.
